(19) United States
(12) Patent Application Publication
(10) Pub. No.: US 2016/0161017 A1
(43) Pub. Date: Jun. 9, 2016

(54) HYDRAULIC MOTOR COMPARTMENT WITH HYDRAULIC MOTOR DRIVE

(71) Applicant: WOCO Industrietechnik GmbH, Bad Soden-Salmunster (DE)

(72) Inventor: Jan Schiller, Hanau (DE)

(21) Appl. No.: 14/958,540

(22) Filed: Dec. 3, 2015

(30) Foreign Application Priority Data
Dec. 8, 2014 (DE) 202014105923.7

(51) Int. Cl. F16K 31/122; F04C 15/00; F01P 7/14; F01M 1/16; F01P 3/20; F01P 5/12; F04C 2/14; F01M 1/02

(52) U.S. Cl. CPC F16K 31/122; F04C 2/14; F04C 15/008; F01M 1/02; F01M 1/16; F01P 3/20; F01P 5/12; F01P 7/14; F01P 2007/146

(57) ABSTRACT

The present invention relates to an actuator for adjusting at least one actuating component in a motor vehicle comprising at least one linearly movable actuating element that can be brought into operative connection with the actuating component at least indirectly, wherein the actuating element can be activated by means of at least one hydraulic drive.

The present invention relates to an actuator for adjusting at least one actuating component in a motor vehicle comprising at least one linearly movable actuating element that can be brought into operative connection with the actuating component at least indirectly, wherein the actuating element can be activated by means of at least one hydraulic drive.

Various actuators are used for adjusting a wide variety of actuating components in motor vehicles.

Thus, U.S. Pat. No. 6,519,939 B1, for example, discloses a generic actuator in the form of a hydraulic system having a compensator, which can be used in automobiles in particular. It is proposed that a hydraulic pump is driven by an electric motor, so that a hydraulic fluid can be pumped back and forth between two chambers of a cylinder, separated from one another by a piston that is movable in the cylinder and is connected to an actuating element.

Another generic actuator in the form of a hybrid electric/hydraulic drive system is known from U.S. Pat. No. 6,126,401. It is proposed that a hydraulic fluid can be pumped back and forth between two chambers in a cylinder separated from one another by a piston. It is proposed that the piston be designed as a double-rod piston in order to avoid the need for a compensating vessel.

However, the actuators already known from the prior art have the disadvantage that comparatively expensive electric drives must be used for the pumps. When using the actuator in motor vehicles in particular, the drive unit of the pump must be able to withstand high temperatures and high vibrational loads in a physical limiting range. To achieve this resistance, comparatively expensive engines must be used.

The object of the present invention is therefore to improve upon the generic actuators, so that the disadvantages of the prior art are overcome, in particular so that an actuator, which has a resistant design that can be implemented inexpensively at the same time, can be made available.

This object is achieved according to the invention by the fact that the hydraulic drive comprises at least one hydro motor.

In addition it is proposed that the hydraulic drive shall comprise at least one cylinder, wherein the interior of the cylinder can be subdivided into at least one first chamber region and at least one second chamber region by means of at least one first piston that is in operative connection preferably to the actuating element and is connected in particular to the actuating element.

With the aforementioned embodiment, it is particularly preferred that at least one pump device, preferably comprising at least one gear pump, can be driven by means of the hydro motor, wherein a hydraulic medium can be conveyed by means of the pump device from the first chamber region into the second chamber region and/or from the second chamber region into the first chamber region, wherein the hydro motor can preferably be driven by means of at least one drive fluid, in particular a drive fluid which circulates, is stored and/or is kept on hand at least partially within the motor vehicle and/or interacts with at least one internal combustion engine in the motor vehicle, preferably by means of the pressure supplied by the working fluid, wherein the drive fluid comprises motor oil and/or cooling fluid in particular and/or the hydro motor is operatively connected to the pump unit by means of at least one coupling device, in particular being connected thereto.

It is also preferred that the drive fluid is carried away by the hydro motor by means of at least one first line and/or by means of at least one second line and/or the supply and/or removal of the drive fluid is/are controlled and/or regulated by means of at least one valve device, which is preferably operatively connected to the first line and/or the second line.

The three embodiments mentioned above may be characterized by at least one storage element, which is fluidically connected to the interior of the cylinder, in particular the first chamber region and/or the second chamber region, wherein at least one second piston is preferably arranged inside the storage element, and in particular an interior space of the storage element can be subdivided into at least one buffer region and at least one second buffer region, wherein the first buffer region is preferably fluidically connectable to the first chamber region and/or the second buffer region is fluidically connectable to the second chamber region.

In addition, an actuator according to the invention can be characterized by at least one sensor device that is operatively connected to the actuating element, the actuating component, the first piston, the second piston, the pump device, the hydro motor, the storage element, the valve device and/or the coupling device.

It is also particularly preferred for at least one control and/or regulating unit that is operatively connected to the hydro motor, the coupling device, the first line, the second line, the valve device, the pump device, the sensor device and/or the storage element to be provided, wherein the position of the actuating element is adjustable in a controlled and/or regulating manner by means of the control and/or regulating device, preferably as a function of at least one measured value output by the sensor device, a control signal and/or a parameter of the motor vehicle, in particular of an internal combustion engine and/or the actuating component of the motor vehicle.

In addition, the invention proposes that the actuating component shall comprise at least one flap, in particular a wastegate valve of a turbocharger and/or at least one valve, in particular an air recirculation valve, a butterfly valve and/or an exhaust gas recirculation valve.

Furthermore, it is proposed with the invention that the actuating element shall comprise at least one operating rod, at least one cable such as a Bowden cable and/or at least one lever, in particular for generating a rotational movement.

Finally, it is proposed with the invention that at least one liquid comprising at least one oil, water, alcohol, ester, glycol and/or ionic liquid can be used in the hydraulic actuator as the hydraulic medium.

The invention is thus based on the surprising finding that the advantages of a hydraulic drive of an actuator can be brought into harmony with an inexpensive and compact design by using a hydro motor as the drive unit for the hydraulic drive. A hydro motor in the sense of the present invention is understood to be a unit that can convert hydraulic energy, i.e., pressure multiplied times volume, into mechanical work. In particular the hydro motor makes it possible to convert energy transported in a hydraulic drive fluid into rotational energy by a compressive action, for example, by pressure acting on gearwheels or the like.

In comparison with pneumatic or electromechanical drives, the actuator according to the invention thus has the advantage that comparatively high forces can be built up. It does not require a transfer of forces supplied by an electrically driven motor, which are then transferred to gearwheels, cams, threaded spindles and/or levers by means of various mechanical gears.

In addition, the hydraulic drive offers the advantage that it does not have the inertia associated with the aforementioned gear devices, and therefore rapid actuating movements can be achieved. This makes the actuator according to the invention particularly suitable for being usable for adjusting a so-called wastegate valve of a turbocharger.

The hydraulic drive supplies in particular a linear movement of the actuating element, in particular a control rod, so that it is possible to supply a lift, which can then move the wastegate valve of an exhaust gas turbocharger, for example. The control rod is subjected to a translational adjustment and is driven by a hydraulic cylinder and/or a hydraulic piston.

For adjusting the hydraulic piston, it is necessary to build up a suitable pressure in a hydraulic medium, which is built up by a pump driven by the hydro motor according to the invention.

In particular, use of the hydraulic drive fluid for driving the hydro motor makes the actuator suitable for being used in a motor vehicle. Then a motor oil circulation, for example, is made available in motor vehicles having an internal combustion engine as the drive medium suitable for driving the hydro motor. Then the hydro motor can be activated by an electric control unit, so that it drives a pump device, in particular a gear pump, to achieve movement of the hydraulic fluid for movement of the operating rod.

With the actuator according to the invention, it is particularly advantageous that the energy made available by the hydraulic drive fluid driving the hydro motor can be transferred essentially without loss to the hydraulic medium, which then transfers this energy, i.e., force, to the actuating element without any loss. This therefore yields an energy advantage in comparison with mechanical actuators and/or pump devices driven by electric motors.

A smaller design size of the actuator and thus significant weight savings are also made possible without having to accept any sacrifices with regard to the possible actuating forces at high actuating speeds. Thus, utilization of the hydraulic cycle, which is present in the motor vehicle for driving the pump mechanism in the actuator, contributes toward a greater compactness and weight savings.

Additional features and advantages are derived from the following description, in which preferred embodiments of the actuator according to the invention are explained on the basis of schematic drawings, in which:

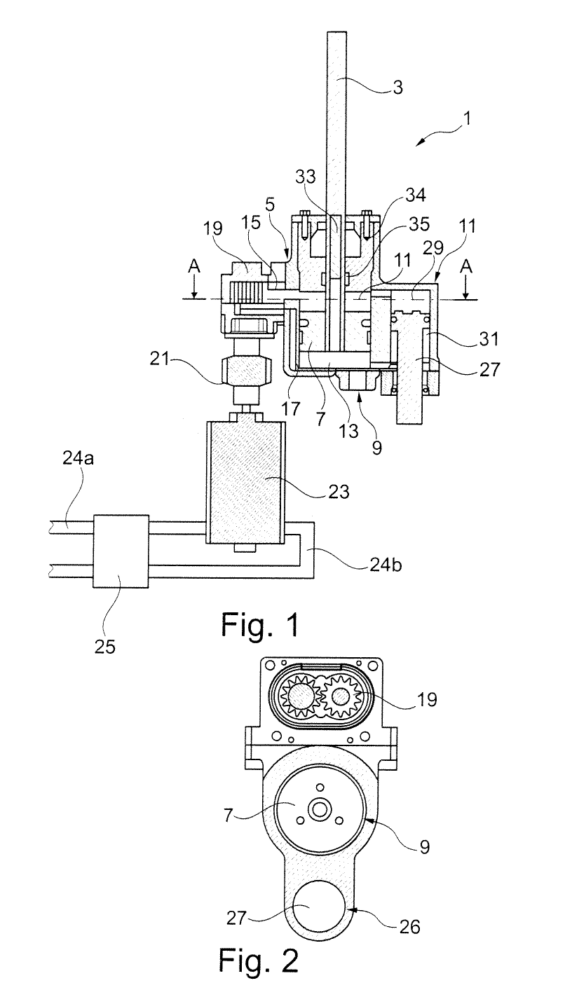

FIG. 1 shows a schematic cross-sectional view of an actuator according to the invention; and

FIG. 2 shows a schematic cross-sectional view of the actuator from FIG. 1, as seen from the direction A in FIG. 1.

FIG. 1 shows schematic cross-sectional view of an actuator 1 according to the invention. An actuating component (not shown in the figure), such as a wastegate valve of a turbocharger, can be adjusted by means of the actuator 1. To do so, the actuator 1 has an actuating element in the form of an operating rod 3. The operating rod 3 can be moved by means of a hydraulic drive 5.

As will be explained below, the hydraulic drive 5 is designed as a closed system. This means that there is no connection between the interior of the hydraulic drive, in which a hydraulic medium is situated, and the exterior atmosphere, and furthermore, all the interior spaces of the hydraulic drive are filled with the hydraulic medium, so there are no (compressible) gas/air clearances in particular. The hydraulic drive 5 comprises a first piston 7, which is connected to the operating rod 3. The first piston 7 is arranged in a cylinder 9.

The interior space of the cylinder 9 is subdivided by the piston 7 into a first chamber region 11 and a second chamber region 13. The first chamber region 11 has a first opening 15, while a second opening 17 opens into the second chamber region 13. A pump mechanism in the form of a gear pump 19 is arranged in a connecting line between the openings 15, 17. The gear pump 19 is connected to a motor in the form of a hydro motor 23 by means of a coupling device 21. The coupling device 21 fulfills in particular the function of a gear for a step down and/or step up. It may be provided in particular that a step-up ratio and/or step-down ratio of the coupling device 21 is/are variable.

A hydraulic drive fluid, in particular motor oil of an internal combustion engine (not shown), is supplied to and/or removed from the hydro motor 23 by way of a line 24a and/or 24b. The (compressive) energy contained in this drive fluid is converted into mechanical work by the hydro motor 23. The supply and removal of the drive fluid are controlled and/or regulated by means of a valve device 25, as will be explained below.

As shown in FIG. 1 in particular, a portion of the volume of the first chamber region 11 is taken up by the portion of the operating rod 3, which protrudes into the chamber region 11. Thus the volume of the first chamber region 11 differs from the volume of the second chamber region 13. To compensate for these volume differences, the actuator 1 also has a storage element 26. The storage element 26 may be designed in the form of a cylinder, in which a second piston 27 is arranged.

An interior space of the storage element 27 is subdivided by the piston 27 into a first buffer region 29 and a second buffer region 31.

FIG. 2 shows a cross-sectional view of the actuator 1 from direction A in FIG. 1. FIG. 2 shows in particular the gear pump 19, the first cylinder 9 with the first piston 7 arranged therein as well as the storage element 26 in the piston 27 arranged therein.

The functioning of the actuator 1 will now be explained below.

The actuator 1 is suitable for vehicles having a supercharged spark ignition engine in particular. The amount of exhaust gas necessary for driving the exhaust gas turbocharger is controlled and/or regulated by means of the actuator 1. To do so, continuous control of the amount of exhaust gas is achieved by continuous adjustment of the valve by means of the actuator 1. To control and/or regulate the exact position of the operating rod 3, the actuator 1 has a control and/or regulating device (not shown). The rotational speed of the hydro motor 23 and/or of the gear pump 19 is regulated and/or controlled accordingly on the basis of the measured values supplied by a sensor device. The sensor device comprises in particular a magnet 33 arranged in the operating rod 3 and a magnetic field sensor 35 arranged in a housing 34 of the actuator. The hydro motor 23 is varied by means of the regulating and/or control device by control of the working fluid supplied to the hydro motor 23 via the line 24a, 24b and/or a step-up ratio and/or a step-down ratio of the coupling device 21. A magnetic 33 is thus arranged on the operating rod 3 for accurate positioning of the operating rod 3, wherein a magnetic sensor 35 is placed in the cylinder head of the actuator 1. The magnetic sensor 35 supplies the position of the operating rod 3 to the control and/or regulating device, which controls the hydro motor 23 by taking into account additional information, in particular the operating states of the internal combustion engine (not shown).

This rotation of the hydro motor 23 via the supply of working fluid through the line 24a and removal through the line 24b is transferred to the gear pump 19 by means of the coupling device 21. Therefore, the gearwheels in the gear pump 19 rotate and convey the hydraulic medium present in the first chamber region 11 into the second chamber region 13. The piston 7 and thus the operating rod 3 are therefore moved upward in one direction. This movement ends as soon as the piston 7 has reached a stop in the upper region of the actuator 1.

If the operating rod is to be moved in the opposite direction, the working fluid is supplied through line 24b instead of line 24a via the valve device 25 and is removed through the line 24a, so that the hydro motor 23 then rotates in the opposite direction. The gearwheels of the gear pump 19 thus also rotate in the opposite direction, so that the hydraulic medium is then conveyed from the second chamber region 13 into the first chamber region 11. This in turn causes the piston 7 in FIG. 1 to move downward until reaching a lower stop inside the cylinder 9.

The volumes of the first chamber region 11 and the second chamber region 13 are not equal due to the part of the operating rod 3 protruding into the first chamber region 11. However, the difference in the volumes is compensated by the storage element 26. If the first piston 7 reaches an upper stop, the volume of the hydraulic medium in the chamber 11 is also minimal, whereas in a lower position of the piston 7, the volume of the hydraulic medium is at its maximum. The volume of the second buffer region 31 behaves in the opposite sense.

In addition, the storage element 26 makes it possible for changes in volume of the hydraulic medium due to changes in temperature, for example, to be compensated. In addition, hydraulic media having a lower temperature dependence, such as ionic liquids, may also be used.

The features disclosed in the description above, in the claims and in the drawings may be essential for the invention in their various embodiments, either individually or in any combination.

### LIST OF REFERENCE NUMERALS

1 Actuator
3 Operating rod
5 Hydraulic drive
7 First piston
9 Cylinder
11 First chamber region
13 Second chamber region
15 First opening
17 Second opening
19 Gear pump
21 Coupling device
23 Hydro motor
24a, 24b Line
25 Valve device
26 Storage element
27 Second piston
29 First buffer region
31 Second buffer region
33 Magnet
34 Housing
35 Sensor
A Direction

1. An actuator (1) for adjusting at least one actuating component in a motor vehicle, comprising at least one linearly movable actuating element (3) that can be brought into operative connection with the actuating component, at least indirectly, wherein the actuating element (3) can be actuated by means of at least one hydraulic drive (5), characterized in that the hydraulic drive (5) comprises at least one hydro motor (23).

2. The actuator according to claim 1, characterized in that the hydraulic drive (5) comprises at least one cylinder (9), wherein the interior space of the cylinder (9) can be subdivided into at least one first chamber region (11) and at least one second chamber region (13) by means of at least one first piston (7), which is connected in particular to the actuating element (3) and is operatively connected to the actuating element (3).

3. The actuator according to claim 2, characterized in that at least one pump device, preferably comprising at least one gear pump (19) can be driven by means of the hydro motor (23), wherein a hydraulic medium can be conveyed by means of the pump device (19) from the first chamber region (11) into the second chamber region (13) and/or from the second chamber region (13) into the first chamber region (11), wherein the hydro motor (23) can be driven by means of at least one drive fluid, in particular a drive fluid which circulates, is stored and/or kept on hand at least partially inside the motor vehicle and/or which interacts with at least one internal combustion engine of the motor vehicle, preferably by means of the pressure supplied by the working fluid, wherein the drive fluid comprises in particular motor oil and/or cooling fluid and/or the hydro motor (23) is operatively connected by means of at least one coupling device (21) to the pump device (19), in particular being connected thereto.

4. The actuator according to claim 3, characterized in that the drive fluid is supplied to the hydro motor (23) by means of at least one first line (24a, 24b) and/or is removed from the hydro motor (23) by means of at least one second line (24b, 24a) and/or the supply and/or removal of the drive fluid is/are controlled and/or regulated by means of at least one valve device (25), which is preferably operably connected to the first line (24a) and/or to the second line (24b).

5. The actuator according to claim 2, characterized by at least one storage element (26), which is fluidically connected to the interior space of the cylinder (9), in particular the first chamber region (11) and/or the second chamber region (13), wherein at least one second piston (27) is preferably arranged inside the storage element (26), in particular an interior space of the storage element (26) being divisible into at least one first buffer region (29) and at least one second buffer region (31), wherein preferably the first buffer region (29) is fluidically connectable to the first chamber region (11) and/or the second buffer region (31) is fluidically connectable to the second chamber region (13).

6. The actuator according to claim 1, characterized by at least one sensor device (35), which is operatively connected to the actuating element (3), the actuating component, the first piston (7), the second piston (27), the pump device (19), the hydro motor (23), the storage element (26), the valve device (25) and/or the coupling device (21).

7. The actuator according to claim 1, characterized by at least one control and/or regulating device, which is operatively connected to the hydro motor (23), the coupling device (21), the first line (24a), the second line (24b), the valve device (25), the pump device (19), the sensor device (35) and/or the storage device (26), wherein the position of the actuating element (3) is adjustable in a controlled and/or regulated manner by means of the control and/or regulating device, preferably as a function of at least one measured value output by the sensor device (35), a control signal and/or a parameter of the motor vehicle, in particular of an internal combustion engine and/or of the actuating component of the motor vehicle.

8. The actuator according to claim 1, characterized in that the actuating component comprises at least one flap, in particular a wastegate valve of a turbocharger and/or at least one valve, in particular an air recirculation valve, a butterfly valve and/or an exhaust gas recirculation valve.

9. The actuator according to claim 1, characterized in that the actuating element comprises at least one operating rod (3), at least one cable such as a Bowden cable and/or at least one lever, in particular for producing a rotational movement.

10. The actuator according to claim 1, characterized in that at least one liquid comprising at least one oil, water, alcohol, ester, glycol and/or ionic liquid can be used as the hydraulic medium in the hydraulic actuator (1).
